(19) United States
(12) Patent Application Publication
(10) Pub. No.: US 2004/0046064 A1
(43) Pub. Date: Mar. 11, 2004

(54) Fuel injection valve and cylinder injection type internal combustion engine installing the same

(75) Inventors: Takuya Shiraishi, Tokyo (JP); Motoyuki Abe, Tokyo (JP); Shuuichi Shimizu, Tokyo (JP); Masahiko Hayatani, Tokyo (JP)

Correspondence Address: CROWELL & MORING LLP, INTELLECTUAL PROPERTY GROUP, P.O. BOX 14300, WASHINGTON, DC, 20044-4300, US

(73) Assignee: Hitachi, Ltd.

(21) Appl. No.: 10/657,259

(22) Filed: Sep. 9, 2003

(30) Foreign Application Priority Data
Sep. 9, 2002 (JP) 2002-262213
May 1, 2003 (JP) 2003-126587

(51) Int. Cl. F02M 61/00

(52) U.S. Cl. 239/533.12

(57) ABSTRACT

A fuel injection valve to give the turn power around the center axis line of injection hole 17 to the fuel injected from the injection hole 17 by swirler 23. Center axis line E of injection hole 17 is inclined with respect to the center axis line C of said valve element by the fixed deflection angle β, and step difference 25 is formed on the pointed end of injection hole 17.

### BACKGROUND OF THE INVENTION

The present invention relates to a fuel injection valve used for the fuel injection in the internal combustion engine, and a cylinder injection type internal combustion engine installing the same, especially to a fuel injection valve in which the fuel is turned and injected into the cylinder and a cylinder injection type internal combustion engine which is provided with the same.

A fuel injection valve of the nozzle type with a swirler having an injection hole opened and shut by a valve element which moves in a direction of axis line, by which turn power around center axis line of said injection hole is given to fuel injected from the injection hole by a fuel turn means referred as a swirler is known as a fuel injection valve (a fuel injector) used for the fuel injection in the internal combustion engine, especially, a cylinder injection type internal combustion engine which uses gasoline as fuel.

In such a fuel injection valve of the nozzle type with the swirler, the center axis line of said injection hole is inclined with respect to the center axis line of said valve element by the fixed deflection angle (for example, Japanese Patent Application Laid-Open No. 11-159421), or the step difference is formed on the pointed end of said injection hole (for example, Japanese Patent Application Laid-Open No. 2000-329036), in order to deflect the direction of the injection of fuel spray or obtain the desired fuel spray form.

A stratification combustion type engine and a homogeneous combustion type engine have been already known as a cylinder injection type internal combustion engine. The optimization setting such as the direction and the shape of fuel spray, the length of penetration, and the presence or absence of lead fuel spray of the fuel injected into the cylinder by the fuel injection valve is different in each internal combustion engine of each model according to the relative position between the sparking plug and the fuel injection valve, the combustion system or the combustion chamber shape of the internal combustion engine, etc.

However, because either a method of setting the deflection angle of the injection hole or a method of providing the step difference on the pointed end face of the injection hole are used in the conventional fuel injection valve, the internal combustion engine of each model has the limit to put each data such as the direction and the shape of fuel spray, the length of penetration, and the presence or absence of lead fuel spray of the fuel into the best state from each viewpoint of the combustion performance, the fuel economy, and the exhaust gas performance, thus the setting is not necessarily appropriate.

In the injector of the Japanese Patent Application Laid-Open No. 11-159421, the fuel spray is deflected by arranging an orifice in non-parallel with the center of axis of the injector. As for fuel spray in this case, the fuel spray of the other side of the direction of the deflection becomes long.

### SUMMARY OF THE INVENTION

However, the necessity for putting the deflection on fuel spray might be caused according to the shape etc. of the combustion chamber of an engine. At this time, it is necessary to obtain the best combustion performance in a minimum fuel by flying the formed long fuel spray penetration in a direction of the sparking plug.

The present invention is attained in consideration of the above-mentioned point.

An object of the present invention is to provide a fuel injection valve used for the injection of fuel in the internal combustion engine, and a cylinder injection type internal combustion engine having the same, which has high degrees of freedom and excellent general-purpose properties in order to put each data such as the direction and the shape of fuel spray, the length of penetration, and the presence or absence of lead fuel spray of the fuel into the best state from each viewpoint of the combustion performance, the fuel economy, and the exhaust gas performance.

The present invention adopts the following configuration to achieve the above-mentioned object.

An injector which opens and shuts said fuel passage and injects the fuel, comprising: a valve seat, a movable valve which opens and shuts fuel passage between this movable valve and the valve seat, a driving means having a coil, which drives said movable valve, further comprising a fuel turn member provided on the upstream side of orifice where the fuel is injected, for giving the turn power to the fuel, wherein the orifice is arranged in nonparallel with the center of axis of the injector, and the exit side of said orifice is formed non-vertically to said orifice.

Moreover, the fuel injection valve according to the present invention has the injection hole opened and shut by a valve element which moves in a direction of the axis line. The turn power around the center axis line of said injection hole is given to the fuel injected from the injection hole by the fuel turn means. The center axis line of said injection hole is inclined with respect to the center axis line of said valve element by the fixed deflection angle. Further, the step difference is formed on the pointed end of said injection hole.

### BRIEF DESCRIPTION OF DRAWINGS

FIG. 1 is a sectional view showing one embodiment of the injector.

FIG. 2 is an enlarged view of the injector point.

FIG. 3 is an enlarged view of the injector point.

FIG. 4A and FIG. 4B are enlarged views of the injector point according to another embodiment.

FIG. 5A and FIG. 5B are enlarged views of the injector point according to a further embodiment.

FIG. 6 is a sectional view showing one embodiment of the fuel injection valve according to the present invention.

FIG. 7 is an enlarged sectional view of the major portion of the fuel injection valve according to the embodiment of FIG. 1.

FIG. 8A and FIG. 8B are diagrammatic sectional views showing a long penetration region of the fuel spray taken along in an A-A line.

FIG. 9 is an illustration showing the forms of fuel spray under the normal temperature atmospheric pressure and under the high temperature high pressure by the step difference in the nozzle structure.

FIG. 10A and FIG. 10B are sectional views showing the state of the injection from the fuel injection valve according to this embodiment in the cylinder injection type internal combustion engine.

FIG. 11A and FIG. 11B are diagrammatic views showing the fuel spray pattern in the combustion chamber by the fuel injection valve according to this embodiment.

FIG. 12 is a graph showing the changes in the pressure and the temperature in the combustion chamber of the internal combustion engine.

FIG. 13 is a graph showing the experimental result of EGR (Exhaust Gas Recirculation) rate and NOx emission amount.

FIG. 14 is a graph showing the experimental result of the fuel spray pattern and HC (hydrocarbon) emission amount.

FIG. 15 is a graph showing the experimental result of the penetration in a direction of the combustion chamber and the HC emission concentration.

### DETAILED DESCRIPTION OF THE PREFERRED EMBODIMENTS

The present invention adopts the following configuration to achieve the above-mentioned object.

An injector which opens and shuts said fuel passage and injects the fuel, comprising: a valve seat, a movable valve which opens and shuts fuel passage between this movable valve and the valve seat, a driving means having a coil, which drives said movable valve, further comprising a fuel turn member provided on the upstream side of orifice where the fuel is injected, for giving the turn power to the fuel, wherein the orifice is arranged in nonparallel with the center of axis of the injector, and the exit side of said orifice is formed non-vertically to said orifice.

The length of fuel spray can be controlled according to this configuration.

Moreover, the fuel injection valve according to the present invention has the injection hole opened and shut by a valve element which moves in a direction of the axis line. The turn power around the center axis line of said injection hole is given to the fuel injected from the injection hole by the fuel turn means. The center axis line of said injection hole is inclined with respect to the center axis line of said valve element by the fixed deflection angle. Further, the step difference is formed on the pointed end of said injection hole.

The deflection injection according to the deflection angle is carried out in the fuel injection valve according to this invention, because the center axis line of said injection hole is inclined with respect to the center axis line of said valve element by the fixed deflection angle. The concentration area of the fuel spray penetration can be set at the arbitrary position around the center axis line of the injection hole by setting the length of the axis of the injection hole in addition to the turn injection. Moreover, the fuel spray form and the fuel spray distribution can be adjusted by providing the step difference on the pointed end of the injection hole. The actions depending on these setting work synergistically or counterbalance by combining these setting. Therefore, each data such as the direction and the shape of fuel spray, the length of penetration, and the presence or absence of lead fuel spray of the fuel can be set variously.

The step difference on the pointed end of said injection hole of the fuel injection valve according to the present invention can be mutually parallel to the plane with the arbitrary tilt angle to the center axis line of said injection hole. It may be an orthogonal plane which makes a right angle with the center axis line of the injection hole as the one.

The pointed end of said injection hole of the fuel injection valve according to the present invention is a cutting work side or a press working side, and the length of the axis of the injection hole and the form and direction of the step difference of the pointed end of the injection hole can be arbitrarily set by the cutting work or press working on the pointed end of the injection hole.

The cylinder injection type internal combustion engine according to the present invention is provided with the fuel injection valve according to the above-mentioned invention.

In this cylinder injection type internal combustion engine, the fuel injection valve in which the length of the axis of the injection hole and the form and direction of the step difference of the pointed end of the injection hole are adapted according to the internal combustion engine is installed. Each data such as the direction and the shape of fuel spray, the length of penetration, and the presence or absence of lead fuel spray of the fuel becomes the one corresponding to the combustion system, the shape of the combustion chamber, a relative position between the sparking plug and the fuel injection valve, etc. As a result, the combustion performance, the fuel economy, and the exhaust gas performance are improved.

The present invention further relates to a method of manufacturing a fuel injection valve having an injection hole opened and shut by a valve element which moves in a direction of axis line, by which turn power around center axis line of said injection hole is given to fuel injected from the injection hole by a fuel turn means, the center axis line of said injection hole inclining with respect to the center axis line of said valve element by the fixed deflection angle, and the step difference being formed on the pointed end of said injection hole. The first product is made by setting the length of the axis of said injection hole to the length of the axis which has the adjustment margin. The second products are made by processing the pointed end of said injection hole of said the first product by using cutting work and press working, etc, and adjusting the length of the axis of said injection hole, the step difference form of the pointed end of said injection hole and the direction of the step difference to the deflection direction of said injection hole.

According to the method of manufacturing the fuel injection valve of the present invention, the best fuel injection valve for an internal combustion engine by which each data such as the direction and the shape of fuel spray, the length of penetration, and the presence or absence of lead fuel spray of the fuel is demanded is obtained by carrying out the cutting work, the press working, etc. on the pointed end of the injection hole after the first product is completed, individually setting the length of the axis of the injection hole, the form and direction of the step difference on the pointed end of the injection hole, and making a second product at the final stage of manufacturing.

Hereinafter, an embodiment of the present invention is explained in detail referring to the attached figures.

In the injector, a movable valve is attracted by the magnetic force (magnetic attraction power) generated by the internal coil, and detached from the valve seat. As a result, the fuel is injected. It is known that the form of this injected fuel spray influences the combustion performance of an engine when the injector is used for the engine. Especially, it is demanded to inject fuel spray of the form matched to the shape of the combustion chamber in the cylinder in an injector for a cylinder injection type engine.

Further, the particle size of fuel spray influences the combustion performance of the engine. It is required to make fuel spray minute grain because the smaller this particle size, the more the combustion performance is improved in general.

As a method of making fuel spray minute grain, there is a fuel turn method to give fuel the turn power. This method increases the speed of the fuel spray at injection of fuel by the turn power, forms the fuel spray to a conic form, thins the thickness of the film of the fuel spray, and promotes to make the fuel spray minute grain.

In this method, fuel spray becomes a conic form. The method by which the direction of the injection of the fuel spray is deflected and the length of the fuel spray is extended is disclosed as a method of controlling the form of the fuel spray to adapt an engine. In this method, the fuel spray is deflected by arranging a fuel injection hole (Hereinafter, it is called orifice) in non-parallel with the center of axis of the injector.

Hereafter, an embodiment is explained on the basis of the drawings.

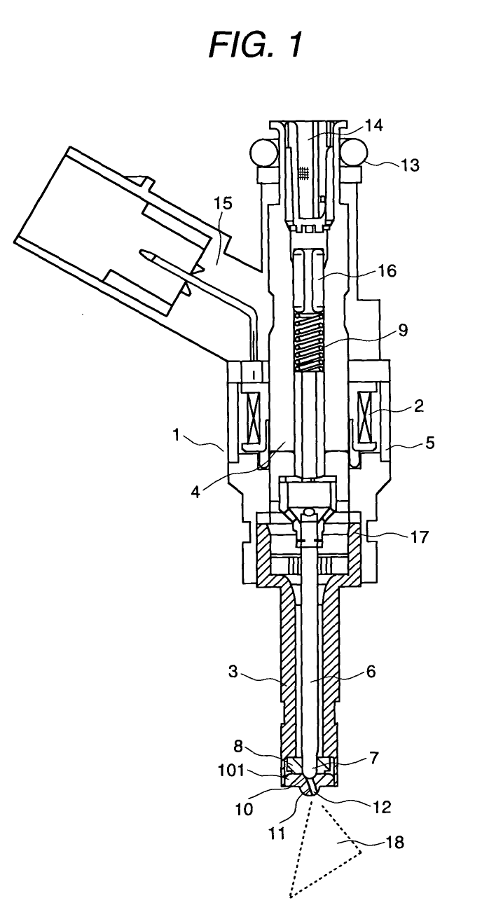

First of all, the structure of injector 1 is explained by using FIG. 1.

The fuel pressurized by fuel pump (not shown) is supplied to injector 1. The fuel passage is opened and shut between valve seat face 10 (seat surface) formed on the side of a nozzle and movable valve 7, and thereby the injection amount of the fuel from orifice 11 is controlled. Orifice 11 and valve seat face 10 are formed to orifice plate 101.

Movable valve 7 is installed at the point of plunger 6, and coil 2 is installed in injector 1 as a means which generates the driving force for movable valve 7.

Return spring 9 which is mechanical spring is provided so that plunger 6 and movable valve 7 can be pressed against valve seat face 10 and the valve can be closed when coil 2 is not turned on and there is no attraction,.

The magnetic flux is produced when coil 2 is turned on, and a magnetic path is formed through core 4, york 5, and plunger 6. As a result, the magnetic attraction power is generated between core 4, york 5, and plunger 6. Therefore, plunger 6 and movable valve 7 shifts in a direction (upward in FIG. 1) of detachment from the valve seat face 10, and the fuel is injected from orifice 11.

Fuel turn member 8 (swirler) or a part by which the turn power is given to the fuel is provided in the neighborhood of the valve seat face 10 to make the fuel minute grain. Therefore, injected fuel spray 18 is formed like the cone.

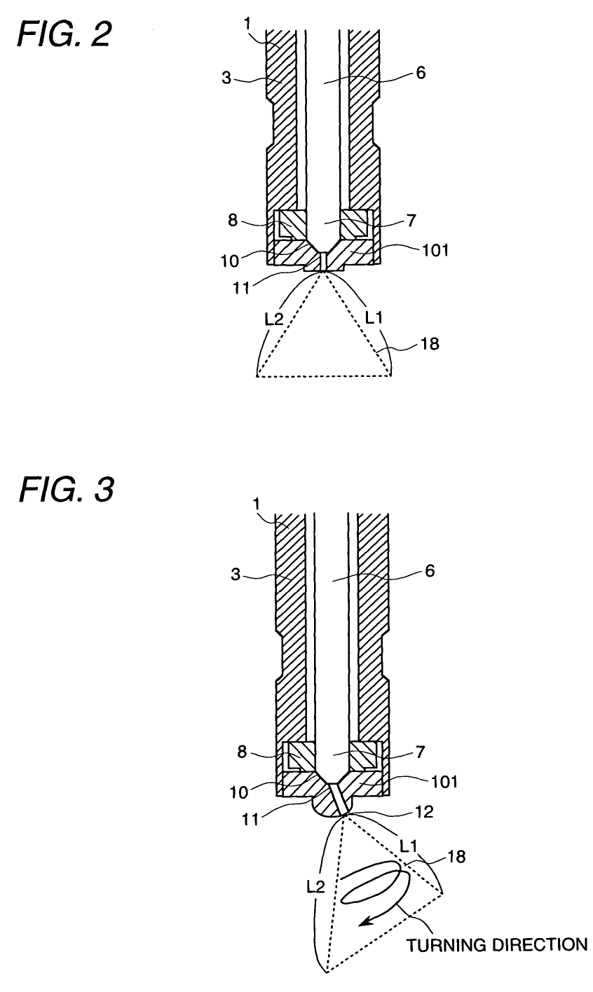

When orifice 11 is arranged in parallel with the center of axis of injector 1, and exit 12 of the orifice is formed to orifice 11 almost vertically as shown in FIG. 2, the length of fuel spray 18 almost becomes even over the circumference (The ratio of the length of fuel spray 18:L1/L2≈1).

On the contrary, when orifice 11 is arranged in non-parallel with the center of axis of injector 1, and exit 12 of the orifice is formed to orifice 11 almost vertically as shown in FIG. 3, the fuel spray 18 is formed at a tilt against the center of axis of injector 1, and the length of fuel spray 18 almost becomes non uniform (The ratio of the length of fuel spray 18:L1/L2≠1).

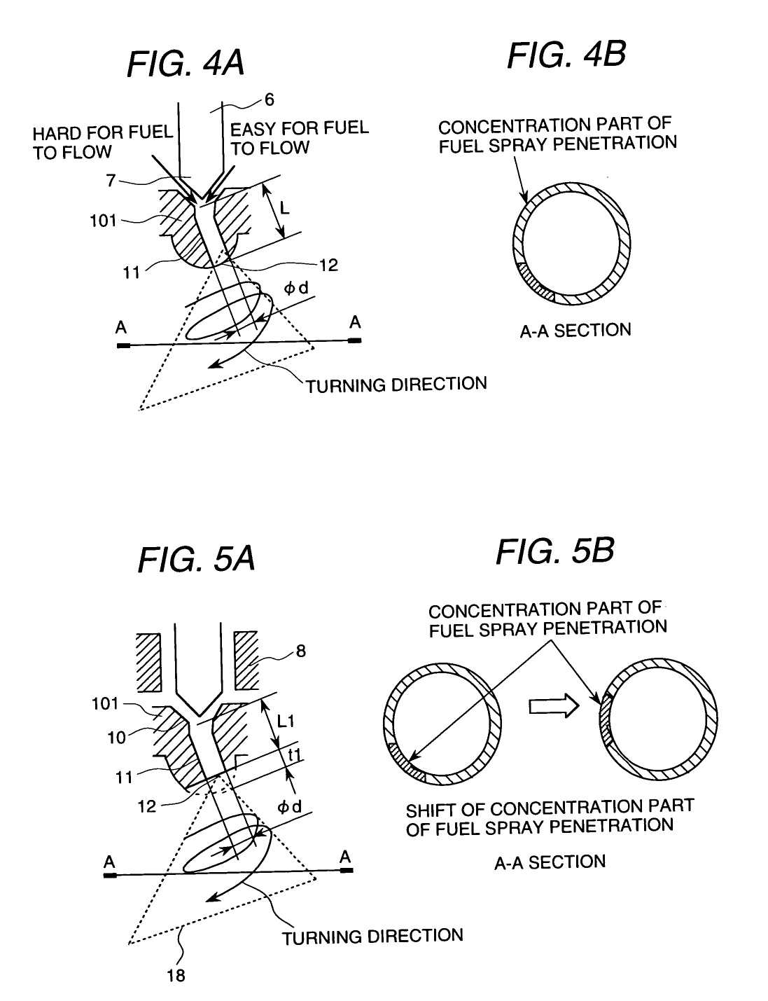

Next, another embodiment is explained by using FIG. 4 to FIG. 6.

FIG. 4 shows the position where the penetration length of fuel spray 18 is the longest.

The hole diameter of orifice 11 is φ0.67 mm in this example, and the hole is arranged in non-parallel with the center of axis of injector 1 an at a tilt by about 20°. Further, length L of the orifice is 1.46 mm, and the exit 12 of the orifice is formed to orifice 11 almost vertically.

Thus, since orifice 11 is arranged in nonparallel with the center of axis of injector 1, the fuel which flows in orifice 11 comes to flow easily in a direction of the deflection, and comes not to flow easily in the opposite direction of the deflection. As a result, the flow velocity distribution of the fuel in the axial direction of orifice 11 is different.

In a word, the step difference of the flow velocity distribution of the fuel in the axial direction of this orifice 11 causes non-uniformity of the penetration length of fuel spray 18 when the fuel is injected from orifice exit 12.

when fuel turn member 8 (not shown in FIG. 4) is installed in injector 1 as mentioned above, the turn power is applied to the fuel flowed in orifice 11. Therefore, the position where the penetration length of fuel spray 18 of the fuel injected from orifice exit 12 is the longest can be generated in the part which shifts from the center location of the axis as shown in the A-A section of FIG. 4 (confirmation from the nozzle side).

It becomes possible to obtain the best combustion in a minimum fuel by turning the position where the penetration length of this fuel spray 18 is the longest in a direction of sparking plug (not shown).

Then, the means to obtain the best combustibility is provided by controlling suitably the position where the penetration length of fuel spray 18 is the longest in this embodiment.

A method of controlling the position where the penetration length of fuel spray 18 is the longest is shown in FIG. 5.

Fuel spray 18 injected from the orifice exit 12 is turned right by fuel turn member 8. The fuel spray flows in orifice 11 through valve seat face 10.

At this time, since orifice 11 is arranged in non-parallel with center 100 of axis of injector 1, the fuel which flows in orifice 11 comes to flow easily in a direction of the deflection, but it comes not to flow easily to the opposite direction of the deflection. The distribution of the flow velocity in the axial direction of orifice 11, of the fuel which flows in orifice becomes non uniform by the mixing of the strong flow velocity and the weak flow velocity in the axial direction.

Further, the strong flow velocity and the weak flow velocity which f low in orifice 11 reaches orifice exit 12, rotating in a right direction, because the right turn power is always given to the fuel.

In a word, the long penetration part of fuel spray 18 is formed when the part with strong flow velocity in the axial direction in orifice 11 is injected from orifice exit 12. The position of this long penetration part of fuel spray 18 is decided by which position of orifice exit 12 the part with strong flow velocity which always rotates in the axial direction in orifice 11 is injected at.

In the case shown in the embodiment, it is possible to adjust the length of the flow path of orifice 11 by cutting the length L of the orifice vertically to the center of the axis in non-parallel with orifice 11 in the amount t1 (t1=L−L1) of cutting. And, the number of revolutions of the fuel to the orifice exit can be adjusted. As a result, the long penetration part of fuel spray 18 can be moved on the center axis of A-A section of fuel spray 18(confirmation from the nozzle side).

In this embodiment, The long penetration part of fuel spray 18 rotates right by about 8° (confirmation from the nozzle side) per cutting amount t1=about 0.1 mm in A-A section.

Moreover, the relation of rotating angle Pdeg of the penetration and this cutting amount t1 can be obtained by [Pdeg=((t1×tan(θ/2))/(π×d0))×360].

In the above expression, t1 designates the cutting amount of orifice 11, θ the angle of a main fuel spray of fuel spray 18, and π ratio of the circumference of a circle to its diameter, and d0 the diameter size of orifice 11.

In a word, to decide the required flow amount and the main fuel spray angle θ when fuel spray 18 is designed, the specifications of the diameter size of orifice 11 and fuel turn member 8 which is part to give the turn power to the fuel are decided.

At this time, at which position the long penetration part of fuel spray 18 is set can be freely set by using the expression by which the above-mentioned Pdeg is obtained (That is, a long penetration part (fuel spray penetration concentrated part) in the section of a certain fuel spray (A-A section in the embodiment) can be adjusted to the arbitrary angle of 360 degrees). As a result, it is possible to control the long penetration part of fuel spray 18 at a position where the engine combustion is carried out efficiently without the limitation of the installation of injector 1.

A long fuel spray penetration part can be freely turned in a direction of the object by controlling the flow velocity distribution of the fuel spray form according to this embodiment. Moreover, because the number of revolutions to reaching to the orifice exit by the fuel can be adjusted by adjusting the total length of orifice, it is possible to turn a long fuel spray penetration part in an arbitrary direction predetermined.

Moreover, an electromagnetic fuel injection valve which has the structure which can control the long penetration part of the fuel spray injected to a conic form by the upstream swirl.

An electromagnetic fuel injection valve which the position where fuel spray is long was adjusted can be provided according to this embodiment.

Next, the embodiment with the step difference formed is explained.

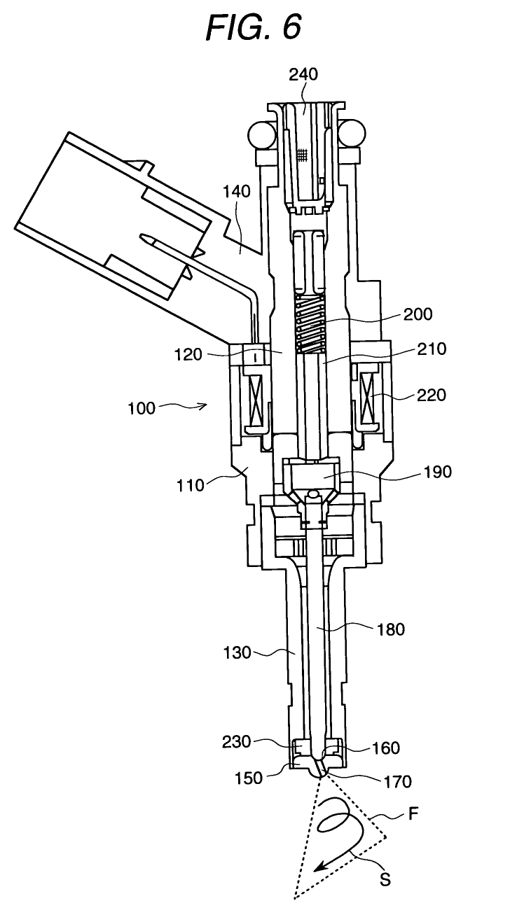

FIG. 6 shows one embodiment of the fuel injection valve according to the present invention.

Fuel injection valve 100 (hereafter, it is called an injector) has main body case 110, fuel passage member 120, nozzle member 130, and connector housing member 140, etc. Nozzle plate 150 is fixed at a pointed portion of nozzle member 130. Valve seat 160 and injection hole 170 are formed in nozzle plate 150.

A valve element 180 is provided in nozzle member 130 so that it can move in a direction of the axis line. Valve 180 moves in a direction of the axial line, and its pointed portion selectively sits on valve seat face 160, that is, the valve selectively opens and shuts injection hole 170. Plunger 19 is connected with a valve element 18. Compression coil spring 200 is provided in fuel passage member 120. Compression coil spring 200 is energized in the valve-close direction where valve element 180 sits on valve seat face 160 through movable sleeve member 210 and plunger 190.

Electromagnetic coil 220 is provided in main body case 110. Electromagnetic coil 220 is excited by turn-on. As a result, the coil resists the spring power of compression coil spring 200, attracts plunger 190, and pulls a valve element 180 apart from the valve seat face 160.

In nozzle member 130, swirler 230 is provided as a fuel turn means. Swirler 230 is arranged on the side of valve seat face 160 of nozzle plate 150, and gives the turn power around the center axis line of injection hole 170 to the fuel injected from the injection hole 170 to make fuel spray to minute grain.

The fuel pressurized by fuel pump (not shown) is supplied to fuel supply port 240 of injector 100. This fuel arrives at swirler 230 through an internal passage of fuel passage member 120, main body case 110 and nozzle member 130, and is injected from the injection hole 170 to the outside while a valve element 180 is pulled apart from the valve seat face 160 by the energizing of electromagnetic coil 220 to open the valve. This fuel spray becomes turn flow around the center axis line of injection hole 170 by giving the turn power by swirler 230, and is formed like the cone as shown in FIG. 6 by short dashes line F. The amount of the fuel injection in this injector 100 is decided depending on the open time of valve element 180, that is, the energizing time of electromagnetic coil 220.

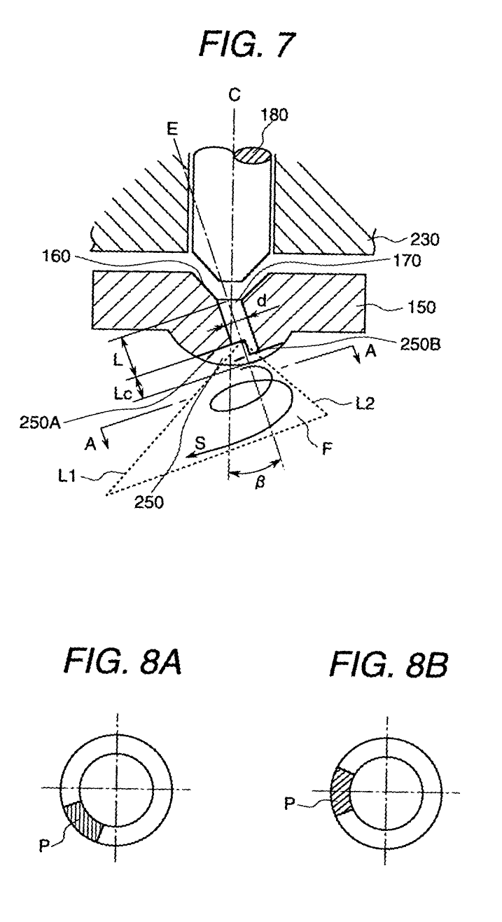

FIG. 7 is an enlarged view of injector 100 according to this embodiment.

In injector 100, center axis line E of injection hole 170 is inclined with respect to center axis line C of a valve element 180 by the fixed deflection angle β (which is equal to the center of axis of injector 100), and step difference 250 is formed on the pointed end of injection hole 170.

Here, step difference 250 is L step so-called, and is formed with two faces 250A and 250B which are parallel with each other. Wherein the pointed end that exists in the pointed portion (exit part) of injection hole 170 have the step difference in a direction of center axis line E of injection hole 107.

When center axis line E of injection hole 170 is inclined with respect to center axis line C of valve element 180 by the deflection angle β, that is, when injection hole 170 is arranged in non-parallel with the center of axis of injector 100 and the pointed end of injection hole 170 is formed on the side almost perpendicular to center axis line E of injection hole 170, fuel spray F deflects to the center of axis of injector 100 and the penetration length of fuel spray F becomes non-uniform (L1/L2≠1).

The fuel which flows into injection hole 170 from the side of valve seat face 160 comes to flow easily in a direction of the deflection, and comes not to flow easily in the opposite direction of the deflection, because injection hole 170 is inclined with respect to the center of axis of injector 100. As a result, the distribution of the flow velocity in an axial direction of injection hole 170 of the fuel which flows through injection hole 170 comes to be different.

In a word, the difference of the flow velocity distribution of the fuel which flows through injection hole 170 generates non-uniformity of the penetration length of fuel spray F.

Because swirler 230 which is a part for giving the turn power to the fuel is provided in injector 100, the turn power is given to the fuel which flows through injection hole 170. Therefore, the area where the penetration length of fuel spray F injected from injection hole 170 is the longest is generated in part P which shifts from the center location as shown in FIG. 8A and FIG. 8B (in the AA section of FIG. 7).

It becomes possible to obtain the best combustion with the smallest fuel by turning area P where the penetration length of fuel spray F is the longest in a direction of the sparking plug in the cylinder injection type gasoline engine in which the stratification combustion is carried out.

Then, the position where the penetration length of fuel spray F is the longest is obtained freely by setting the length L of the axis of injection hole 170. As a result, the best combustibility can be obtained.

The relation between the penetration length of fuel spray F and the position where length L of the axis of this injection hole 170 is the longest is explained.

The fuel given RRC by swirler 230, passes through valve seat face 160, and flows into injection hole 170.

The fuel which flows into injection hole 170 comes to flow easily in a direction of the deflection, and not to flow easily to the opposite direction of the deflection, because injection hole 170 is arranged in non-parallel with the center C of axis of injector 100 (inclination arrangement).

Because strong axial flow velocity and weak axial flow velocity mingles with the flow velocity in an axial direction of injection hole 170 of the fuel which flows through injection hole 170, the flow velocity distribution becomes non uniform. The axially strong flow velocity and the axially weak flow velocity which flow in injection hole 170 reaches the exit of injection hole 170 turning right, because the right turn is always given to the fuel.

In a word, the long penetration part of fuel spray F is formed by the part with axially strong flow velocity in injection hole 170 being injected from the exit of injection hole 170. At which position the long penetration part of this fuel spray F is set depends upon at which position the part with axially strong flow velocity which always rotates in injection hole 170 is injected from the exit of injection hole 170.

This (At which position is the part with axially strong flow velocity which always rotates in injection hole 170 is injected from the exit of injection hole 170) is decided by adjusting or setting length L of the axis of injection hole 170, and adjusting the length of the flow path of injection hole 170 (That is, rotating angle of the fuel to the exit of the injection hole is adjusted). As a result, it becomes possible to move long penetration region P of fuel spray F around the center axis in the AA section of FIG. 2 (confirmation from the nozzle side) as shown in FIGS. 8A and 8B.

Length L of the axis of injection hole 170 can be arbitrarily set according to amount Tc of cutting in the cutting work on the pointed end of the injection hole. Assumed that the long penetration part of fuel spray F turns right by about 8 degrees in the M section (confirmation from the nozzle side) per amount Tc of cutting of 0.1 mm, the relation between rotating angle P deg of the penetration and amount Tc of cutting is shown by under-mentioned expression (1).

(π·D)Pdeg={Tc·tan(θ/2)}/360

In the above-mentioned expression (1), θ is a main angle of spray of fuel spray F, π is a circular constant, and D is a diameter size of injection hole 170.

In a word, to decide the needed flowing amount and the main angle of spray θ when fuel spray F is designed, the data of diameter size D of injection hole 170, length L of the axis and swirler 230 which is a part for giving the turn power to the fuel is decided. At this time, the position of the long penetration part of fuel spray F can be freely set by using the expression to obtain rotating angle Pdeg of the penetration.

That is, a long penetration part (the concentrated part of the flowing amount) in the section of a certain fuel spray (AA section in the embodiment) can be adjusted to the arbitrary angle of 360 degrees. As a result, it becomes possible to set the long penetration part of fuel spray F at a position where the combustion efficiency is best without the restriction on the installation of injector 100.

A long fuel spray penetration part can be freely turned in the desired direction by controlling the flow velocity distribution of the fuel spray form according to this embodiment. Moreover, because the number of revolutions to reaching to the injection hole exit (an amount of the rotation) can be adjusted by adjusting length L of the axis of injection hole 170, it is possible to turn the long spray penetration part to the arbitrary direction predetermined.

Because step difference 250 is formed on the pointed end of injection hole 170(exit side), a long fuel spray penetration part (Hereafter, it is called a lead fuel spray) can be emphasized further.

The inventors confirmed that the lead fuel spray strengthens by setting step difference 250, and the penetration become long. However, the phenomenon that the lead fuel spray disappears was found as another characteristic under the high temperature high pressure (for instance, in atmosphere temperature 160° C. and atmosphere pressure 0.5 MPa). The condition under the high temperature high pressure is set on the assumption that the fuel is injected at the compression stroke of the engine.

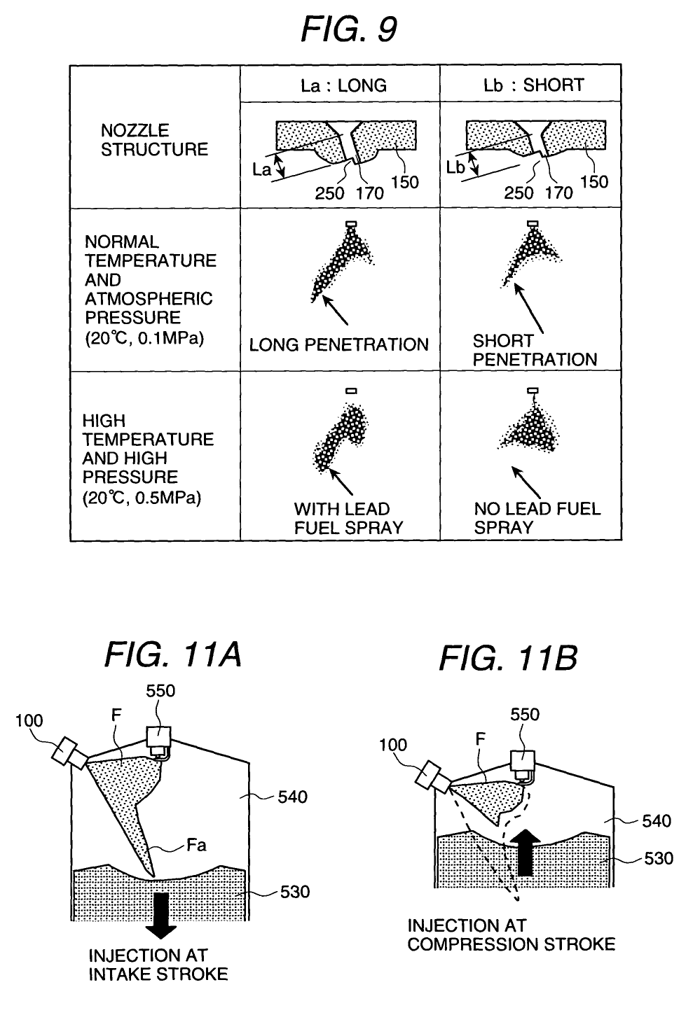

FIG. 9 shows one of the above-mentioned examples.

FIG. 9 shows the comparison example of the fuel spray from injector 100 provided with the nozzle plate having injection hole of long axial length (La) and that from the injector 100 having injection hole of short axial length (Lb).

In the fuel spray from the injection hole of axial length La, a long penetration is observed under the normal temperature and the atmospheric pressure, and the lead fuel spray remains under the high temperature high pressure.

On the other hand, the lead fuel spray under the normal temperature atmospheric pressure is short, and the lead fuel spray has disappeared under the high temperature high pressure in the fuel spray from the injection hole of axial length Lb.

The mechanism that causes this phenomenon is considered as follows.

The step difference on the pointed end of the injection hole causes the deflection of the flowing amount distribution of the fuel spray at the exit part of the injection hole, and the pattern of the fuel spray injected as a result forms non-uniform distribution with the flowing amount concentrated part partially.

In the case that the center axis line of injection hole 170 is concentric with the center axis line of injector 100, the fuel to which the turn power is given by swirler 230 becomes uniform distribution while turning in injection hole 170, and is injected from the exit.

The position where step difference 250 is formed, the angle, and the length of the injection hole can be arbitrarily set at the uniform distribution of the flowing amount.

On the other hand, the deviation of the flowing amount distribution are generated in injection hole 170 as mentioned above in the case that the center axis line of injection hole 170 is inclined by deflection angle β with respect to center axis line C of injector 100.

They work synergistically (superposes) when a deep part of the flowing amount distribution and the influence of the step difference overlap as shown on the left side of FIG. 9 (La:long).

Further, it is thought that they enter the state of the counterbalance when a light part of the flowing amount distribution and the influence of the step difference overlap as shown on the right side of FIG. 9 (Lb:short).

Therefore, it is possible to adjust freely the strength of the lead fuel spray by combining the deflection nozzle technology and the step difference nozzle technology, and to cancel or maintain the lead fuel spray under the high temperature high pressure.

A wide angle of spray which includes the lead fuel spray can be obtained under the normal temperature atmospheric pressure by applying this technology, and the lead fuel spray disappears under the high temperature high pressure and a narrow angle of spray can be achieved. As a result, spray angle variable injector 100 can be provided.

To adapt injector 100 to engine, the length of axis of injection hole 170 is set to the length (L+Lc) which has the margin of adjustment as a first product.

The shape of the pointed end of injection hole 170 of the first product is a hemisphere of spherical diameter (L+Lc) as shown by a virtual line in FIG. 2 as an example.

By carrying out the cutting work with fixed size accuracy to the pointed end (hemisphere part) of injection hole 170 of this first product, the length of the axis of injection hole 170, the shape of step difference 250 of the pointed end of the injection hole and the direction of step difference 250 to the deflection direction of injection hole 170 are adjusted to make a second product. As a result, injector 100 can be adapted briefly to the engine with generality and variety.

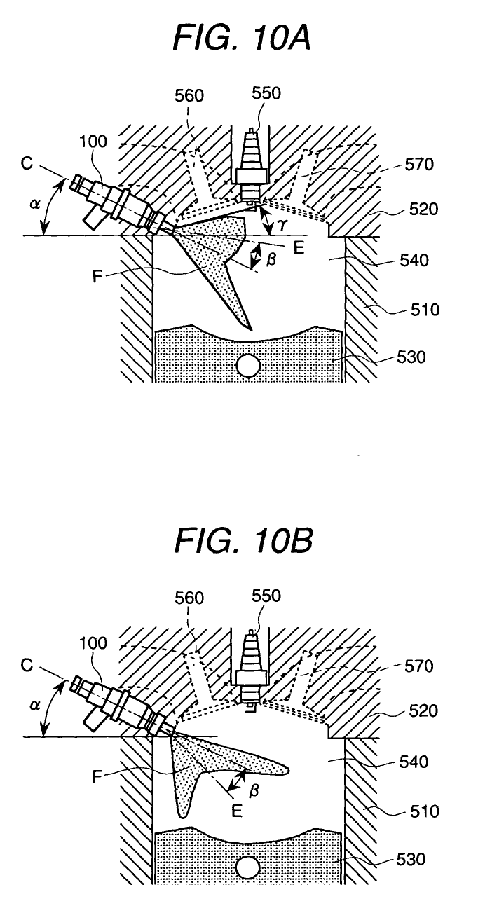

FIG. 10A and FIG. 10B show the cylinder injection type internal combustion engine (gasoline engine) to which injector 100 according to the above-mentioned configuration is applied.

In FIG. 10A and FIG. 10B, 510 designates a cylinder block, 520 a cylinder head, 530 a piston, 540 a combustion chamber (cylinder), 550 a sparking plug, and 560 an inlet valve and 570 an exhaust valve, respectively.

In the cylinder injection type internal combustion engine shown in the figure, the setting angle of injector 100 (angle α from the horizontal line to the center C of axis of the injector) is a small (about 20 degrees). Moreover, center E of axis of the injection hole to inject the fuel to combustion chamber 540 is inclined with respect to center C of axis of injector 100 by β degrees.

In the cylinder injection type internal combustion engine shown in FIG. 10A, the direction of the nozzle deflection is on the sparking plug side. On the other hand, in the cylinder injection type internal combustion engine of FIG. 10B, the direction of the nozzle deflection is on piston upper side. When the angle made by the line which connects between the pointed gap position of sparking plug 550 and the nozzle point position and the horizontal line is assumed to be γ, the deflection direction of the nozzle is set within the range of the angle from center C of axis of injector 100 to γ. That is, the deflection angle β can be set within the range where 0<β<(α+γ).

In this configuration, the behavior of the fuel spray in the engine combustion chamber under each operating state is explained by using FIG. 11A and FIG. 11B.

It is necessary to mix the fuel and air enough to form the homogeneous air-fuel mixture when the fuel is injected by the control signal from an engine control unit (not shown) at the intake stroke. Therefore, the fuel is injected at the wide angle of spray including lead fuel spray Fa as shown in FIG. 11A. In the homogeneous mixture formation, that is, homogeneous combustion, lead fuel spray Fa is injected in a direction of piston 53.

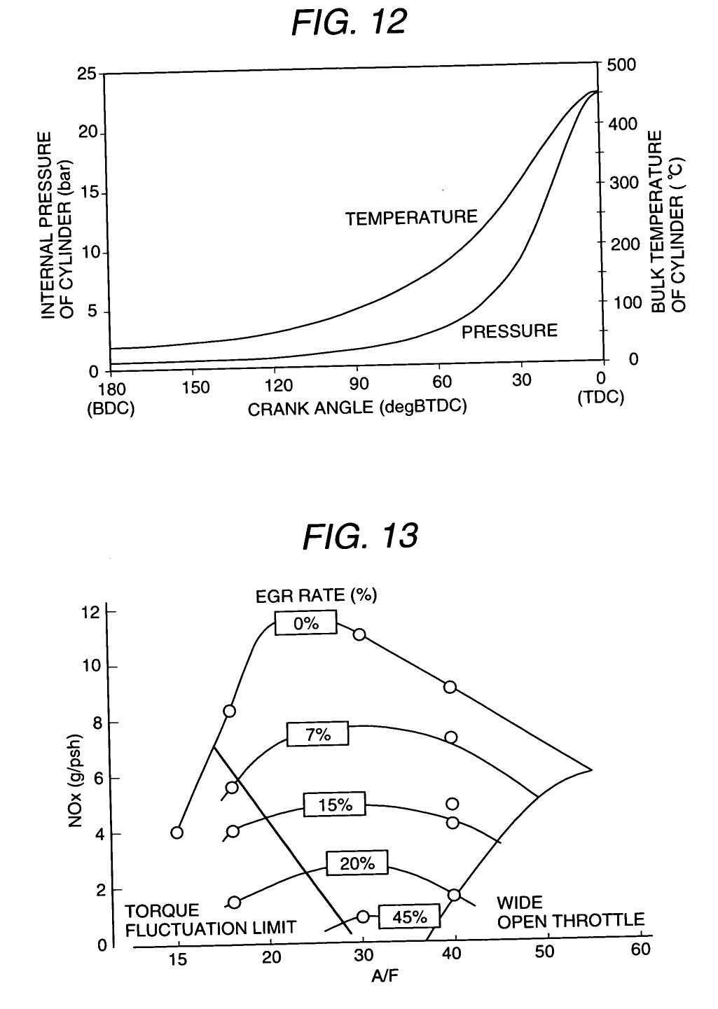

On the other hand, it is necessary to form the stratification air-fuel mixture in which the air-fuel mixture is centralized to the surroundings of sparking plug 550 when the fuel is injected at the compression stroke. The temperature and the pressure of the combustion chamber during the compression stroke rise according to the rise of piston 530 as shown in FIG. 12. At 30 degrees before the top dead center (TDC) for instance, the temperature is at about 300° C. and the pressure is at about 8 bar. Therefore, when the fuel is injected under such a high temperature high pressure as explained by using FIG. 9, lead fuel spray Fa in a direction of piston 530 disappears, and the fuel spray form shown in FIG. 11B is obtained.

Because center E of axis of injection hole 170 is inclined in non-parallel with center C of the injector and directed to a direction of plug 550, the main fuel spray which includes a deep part of the flowing amount distribution is injected in a direction of the plug and it is made a stratification around the plug. At this time, it is desirable to provide the assist of airflow (not shown) such as tumbles and swirls.

In the prior art, the control signal is output to increase the amount of injection when judged by an engine control unit (not shown) that the control amount of the accelerator is large and the demand torque is large. However, there are problems that the adhesion fuel to the piston increases and the smoke occurs. Because the injection amount in a direction of the center of axis of injection hole 170 increases in this embodiment when the injection amount increases, the amount of the adhesion to the piston of the fuel can be decreased, and the smoke exhaust is suppressed.

Further, the fuel spray are prevented from diffusing and the stratification degree (concentrated degree to the sparking plug surroundings) increases because the speed of the main fuel spray injected in a direction of the plug is slower than that of the lead fuel spray. As a result, the amount of the EGR (Exhaust gas Recirculation) can be increased, and both the fuel consumption and the NOx can be decreased.

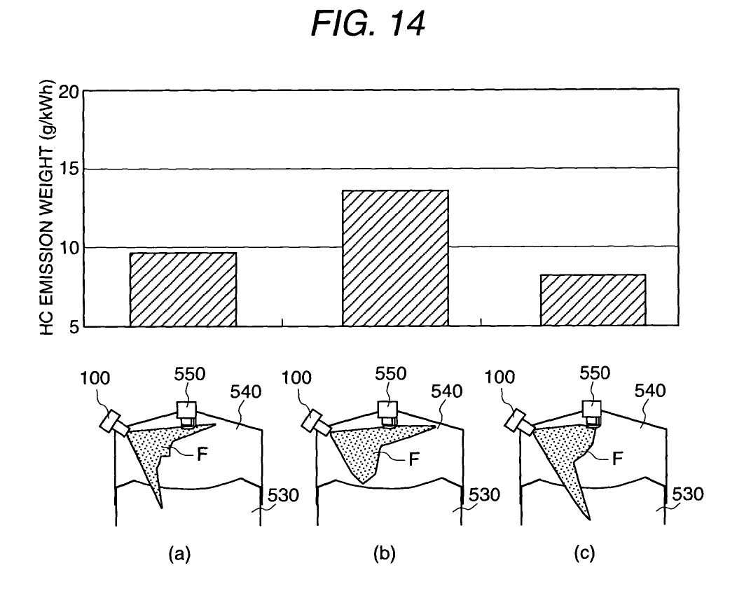

FIG. 13 shows the result. The EGR rate of about 20% is the conventional limit because the combustion become unstable if the EGR is introduced voluminously. This is because the air-fuel mixture is diluted with EGR gas, and the stratification degree deteriorates. Injector 10 according to this embodiment was made for trial purposes and experimented on the performance validation. As a result, it was confirmed that it was possible to increase the EGR rate up to 45% by adjusting air-fuel ratio, and the emission amount of the NOx was decreased.

Moreover, the emission increase in HC (hydrocarbon) is worried about because lead fuel spray Fa is injected in a direction of the piston 530 in the injection form shown in FIG. 11A. Especially, it is necessary to decrease the amount of HC exhausted from the engine because the temperature of the catalyst is low, and the adequate purification performance is not obtained immediately after the engine starting.

When the performance validation was done from such a viewpoint, the results shown in FIG. 14A to FIG. 14C was obtained. As operating conditions, the engine speed is 1400 rpm by which idle state immediately after start-up is imitated, shaft torque 20 Nm, air-fuel ratio 14.7, water temperature=oil temperature=30° C., and four cylinder engine of 1.8L was used.

The image of the fuel spray pattern in the combustion chamber was shown in the lower together.

It is understood from this result that the bigness and smallness of the injection in a direction of the piston does not relate so much to the hydrocarbon exhaust.

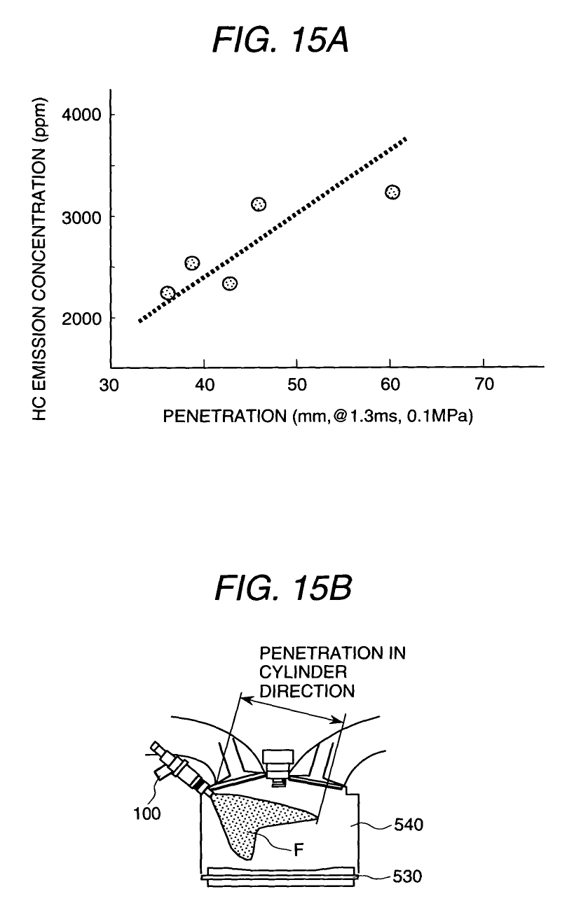

FIG. 15 shows the result of the summary from the viewpoint of penetration in a direction of the combustion chamber. The penetration in a direction of the combustion chamber was measured by using the fuel spray photograph taken after 1.3 sec from the injection beginning where the fuel is injected to the atmosphere under the atmospheric pressure under the conditions of fuel pressure 7 MPa and injection amount 12.5 mcc/times.

It is understood from this result that the main factor to exhaust HC is thought to be the fuel component which adheres around the combustion chamber wall on the opposite side of the injector injection position, and the configuration of this embodiment (the configuration shown in FIG. 10A) is effective in the decrease in HC emission amount immediately after start-up.

The present invention is not limited to said embodiment though only one embodiment of the present invention was explained in details.

For instance, axial length L of injection hole 17 of injector 10 can be arbitrarily set by the cutting work on the injection hole pointed end in said embodiment. In this case, the processing is not limited to the cutting work, and can be carried out by another processing like press working.

The injector which can control the length of the fuel spray can be provided according to the present invention as understood from the above-mentioned explanation. Further, the deflection injection according to the deflection angle can be performed by inclining the center axis line of the injection hole with respect to the center axis line of the valve body by the fixed deflection angle. Therefore, the fuel spray penetration concentration area can be set at the arbitrary position around the center axis line of the injection hole by setting the length of the axis of the injection hole along with the turn injection.

Moreover, the fuel spray form and the fuel spray distribution can be adjusted by the step difference on the pointed end of the injection hole. The actions depending on these setting work synergistically or counterbalance by combining these setting. Therefore, each data such as the direction and the shape of fuel spray, the length of penetration, and the presence or absence of lead fuel spray of the fuel can be set variously. That is, the fuel injection valve according to this invention has a high degree of freedom by which these each data is made optimum state suitable for the internal combustion engine of each model, and excellent generality.

Moreover, the fuel injection valve in which the form and the direction of the step difference on the pointed end of the injection hole and the axial length of the injection hole are adapted to the internal combustion engine can be set up according to the cylinder injection type internal combustion engine according to the present invention.

Each data such as the direction and the shape of fuel spray, the length of penetration, and the presence or absence of lead fuel spray of the fuel becomes the one corresponding to a relative position of the sparking plug and the fuel injection valve, the combustion system, the combustion chamber form, etc. As a result, the combustion performance, the fuel economy, and the exhaust gas performance can be improved.

In addition, the length of the axis of the injection hole and the form and direction of the step difference of the pointed end of the injection hole can be arbitrarily set by the cutting work or press working on the pointed end of the injection hole of the first product in the method of manufacturing the fuel injection valve according to the present invention. Therefore, each data of the fuel can be individually optimized in proportion to the model of the internal combustion engine which applies at the time of manufacturing of the second product.

What is claimed is:

1. A fuel injection valve having an injection hole opened and shut by a valve element which moves in a direction of axis line, by which turn power around center axis line of said injection hole is given to fuel injected from the injection hole by a fuel turn means,
wherein the center axis line of said injection hole is inclined with respect to the center axis line of said valve element by the fixed deflection angle, and
wherein the step difference is formed on the pointed end of said injection hole.

2. A fuel injection valve according to claim 1, wherein the step difference on the pointed end of said injection hole is mutually parallel to the plane with the arbitrary tilt angle with respect to the center axis line of said injection hole.

3. A fuel injection valve according to claim 1 or 2, wherein the pointed end of said injection hole is a cutting work side or a press working side.

4. A cylinder injection internal combustion engine provided with a fuel injection valve according to any one of claims 1 to 3.

5. A method of manufacturing a fuel injection valve having an injection hole opened and shut by a valve element which moves in a direction of axis line, by which turn power around center axis line of said injection hole is given to fuel injected from the injection hole by a fuel turn means, the center axis line of said injection hole inclining with respect to the center axis line of said valve element by the fixed deflection angle, and the step difference being formed on the pointed end of said injection hole,
wherein the first product is made by setting the length of the axis of said injection hole to the length of the axis which has the adjustment margin, and
wherein the second products are made by processing the pointed end of said injection hole of said the first product, and adjusting the length of the axis of said injection hole, the step difference form of the pointed end of said injection hole and the direction of the step difference to the deflection direction of said injection hole.

6. A method of manufacturing the fuel injection valve according to claim 5, wherein the processing on the pointed end of said injection hole is carried out by the cutting work or press working.
